(19) United States
(12) Patent Application Publication
(10) Pub. No.: US 2025/0341435 A1
(43) Pub. Date: Nov. 6, 2025

(54) MAGNETIC-BASED TORQUE SENSOR

(71) Applicant: Allegro MicroSystems, LLC, Manchester, NH (US)

(72) Inventors: Yannick Vuillermet, La Motte Servolex (FR); Xavier Blanc, Annecy (FR); Emanuele Andrea Casu, Annecy (FR)

(73) Assignee: Allegro MicroSystems, LLC, Manchester, NH (US)

(21) Appl. No.: 18/654,582

(22) Filed: May 3, 2024

(51) Int. Cl. G01L 3/10

(52) U.S. Cl. CPC G01L 3/104

(57) ABSTRACT

A system, comprising: a ring magnet that is coupled to a first portion of a mechanical element, the first portion extending in a first direction, the first ring magnet having npp1 pole pairs, where npp1 is an odd integer, and npp1≥3; a second ring magnet that is coupled to a second portion of a mechanical element, the second portion extending in a second direction that is opposite to the first direction, the second ring magnet having npp2 pole pairs, where npp2=4*m*npp2, m is an integer, and m≥1; first and second magnetic field sensor, the first and second magnetic field sensors being disposed at an angle of approximately 90/npp1 degrees relative to each other; and third and fourth magnetic field sensors, the third and fourth magnetic field sensors being disposed at an angle of approximately 180 degrees relative to each other.

### BACKGROUND

As is known, sensors are used to perform various functions in a variety of applications. Some sensors include one or magnetic field sensing elements, such as a Hall effect element or a magnetoresistive element, to sense a magnetic field associated with proximity or motion of a target object, such as a ferromagnetic object in the form of a gear or ring magnet, or to sense a current, as examples. Sensor integrated circuits are widely used in automobile control systems and other safety-critical applications. There are a variety of specifications that set forth requirements related to permissible sensor quality levels, failure rates, and overall functional safety.

### SUMMARY

According to aspects of the disclosure, a system is provided, comprising: a ring magnet that is coupled to a first portion of a mechanical element, the first portion extending in a first direction, the first ring magnet having npp1 pole pairs, where npp1 is an odd integer, and npp1≥3; a second ring magnet that is coupled to a second portion of a mechanical element, the second portion extending in a second direction that is opposite to the first direction, the second ring magnet having npp2 pole pairs, where npp2=4*m*npp2, m is an integer, and m≥1; first and second magnetic field sensor, the first and second magnetic field sensors being disposed at an angle of approximately 90/npp1 degrees relative to each other; and third and fourth magnetic field sensors, the third and fourth magnetic field sensors being disposed at an angle of approximately 180 degrees relative to each other.

According to aspects of the disclosure, a system is provided, comprising: a ring magnet that is coupled to a first portion of a mechanical element, the first portion extending in a first direction, the first ring magnet having npp1 pole pairs, where npp1 is an odd integer, and npp1≥3; a second ring magnet that is coupled to a second portion of a mechanical element, the second portion extending in a second direction that is opposite to the second direction, the second ring magnet having npp2 pole pairs, where npp2=4*m*npp2, m is an integer, and m≥1; a first and second magnetic field sensor, the first and second magnetic field sensors being disposed at an angle of approximately 90/npp1 degrees relative to each other; and a third magnetic field sensor (124), the first and third magnetic field sensors being disposed at an angle of approximately 180 degrees relative to each other.

According to aspects of the disclosure, a method is provided, comprising: receiving signals Bx1 and By1 that are associated with first and second ring magnets, the signal Bx1 being indicative of a strength of a radial magnetic field that is measured by a first magnetic field sensor, and the signal By1 being indicative of a strength of a tangential magnetic field that is measured by the first magnetic field sensor; receiving signals Bx2 and By2 that are associated with the first and second ring magnets, the signal Bx2 being indicative of a strength of a radial magnetic field that is measured by a second magnetic field sensor, and the signal By2 being indicative of a strength of a tangential magnetic field that is measured by the second magnetic field sensor; receiving signals Bx3 and By3 that are associated with the first and second ring magnets, the signal Bx3 being indicative of a strength of a radial magnetic field that is measured by a third magnetic field sensor, and the signal By3 being indicative of a strength of a tangential magnetic field that is measured by the third magnetic field sensor; and receiving signals Bx4 and By4 that are associated with the first and second ring magnets, the signal Bx4 being indicative of a strength of a radial magnetic field that is measured by a fourth magnetic field sensor, and the signal By4 being indicative of a strength of a tangential magnetic field that is measured by the fourth magnetic field sensor; calculating a first angle value based on signals Bx1, Bx2, By1, By2, and a count npp1 of pole pairs in first ring magnet; calculating a second angle value based on signals Bx3, Bx4, By3, By4, and a count npp2 of pole pairs in the second ring magnet; and calculating an indication of torque based on the first angle value and the second angle value, wherein npp1≥3, npp1 is an odd integer, npp2=4*m*npp2, m is an integer, and m≥1.

According to aspects of the disclosure, a method is provided, comprising: receiving signals Bx1 and By1 that are associated with first and second ring magnets, the signal Bx1 being indicative of a strength of a radial magnetic field that is measured by a first magnetic field sensor, and the signal By1 being indicative of a strength of a tangential magnetic field that is measured by the first magnetic field sensor; receiving signals Bx2 and By2 that are associated with the first and second ring magnets, the signal Bx2 being indicative of a strength of a radial magnetic field that is measured by a second magnetic field sensor, and the signal By2 being indicative of a strength of a tangential field that is measured by the second magnetic field sensor; receiving signals Bx4 and By4 that are associated with the first and second ring magnets, the signal Bx4 being indicative of a strength of a radial magnetic field that is measured by a third magnetic field sensor (124), and the signal By4 being indicative of a strength of a tangential magnetic field that is measured by the third magnetic field sensor; calculating a first angle value based on signals Bx1, Bx2, By1, By2, and a count npp1 of pole pairs in first ring magnet; calculating a second angle value based on signals Bx1, Bx4, By1, By4, and a count npp2 of pole pairs in the second ring magnet; and calculating an indication of torque based on the first angle value and the second angle value, wherein npp1≥3, npp1 is an odd integer, npp2=4*m*npp2, m is an integer, and m≥1.

According to aspects of the disclosure, a system is provided, comprising: a memory, a processing circuitry that is operatively coupled to the memory, the processing circuitry being configured to: receive signals Bx1 and By1 that are associated with first and second ring magnets, the signal Bx1 being indicative of a strength of a radial magnetic field that is measured by a first magnetic field sensor, and the signal By1 being indicative of a strength of a tangential magnetic field that is measured by the first magnetic field sensor; receive signals Bx2 and By2 that are associated with the first and second ring magnets, the signal Bx2 being indicative of a strength of a radial magnetic field that is measured by a second magnetic field sensor, and the signal By2 being indicative of a strength of a tangential magnetic field that is measured by the second magnetic field sensor; receive signals Bx3 and By3 that are associated with the first and second ring magnets, the signal Bx3 being indicative of a strength of a radial magnetic field that is measured by a third magnetic field sensor, and the signal By3 being indicative of a strength of a tangential magnetic field that is measured by the third magnetic field sensor; and receive signals Bx4 and By4 that are associated with the first and second ring magnets, the signal Bx4 being indicative of a strength of a radial magnetic field that is measured by a fourth magnetic field sensor, and the signal By4 being indicative of a strength of a tangential magnetic field that is measured by the fourth magnetic field sensor; calculate a first angle value based on signals Bx1, Bx2, By1, By2, and a count npp1 of pole pairs in first ring magnet; calculate a second angle value based on signals Bx3, Bx4, By3, By4, and a count npp2 of pole pairs in the second ring magnet; and calculate an indication of torque based on the first angle value and the second angle value, wherein npp1≥3, npp2=4*m*npp2, m is an integer, and m≥1.

According to aspects of the disclosure, a method is provided, comprising: a memory, a processing circuitry that is operatively coupled to the memory, the processing circuitry being configured to: receiving signals Bx1 and By1 that are associated with first and second ring magnets, signal Bx1 being indicative of a strength of a radial magnetic field that is measured by a first magnetic field sensor, and the signal By1 being indicative of a strength of a tangential magnetic field that is measured by the first magnetic field sensor; receiving signals Bx2 and By2 that are associated with the first and second ring magnets, signal Bx2 being indicative of a strength of a radial magnetic field that is measured by a second magnetic field sensor, and the signal By2 being indicative of a strength of a tangential magnetic field that is measured by the second magnetic field sensor; receiving signals Bx4 and By4 that are associated with the first and second ring magnets, signal Bx4 being indicative of a strength of a radial magnetic field that is measured by a third magnetic field sensor (124), and the signal By4 being indicative of a strength of a tangential magnetic field that is measured by the third magnetic field sensor; calculating a first angle value based on signals Bx1, Bx2, By1, By2, and a count npp1 of pole pairs in first ring magnet; calculating a second angle value based on signals Bx1, Bx4, By1, By4, and a count npp2 of pole pairs in the second ring magnet; and calculated an indication of torque based on the first angle value and the second angle value, wherein npp1≥3, npp2=4*m*npp2, m is an integer, and m≥1.

### BRIEF DESCRIPTION OF THE DRAWINGS

The foregoing features may be more fully understood from the following description of the drawings in which:

FIG. 1A is a planar side view of an example of a system, according to aspects of the disclosure;

FIG. 1B is a planar side view of the system of FIG. 1A when viewed from a different angle, according to aspects of the disclosure;

FIG. 1C is a perspective top-down view of the system of FIG. 1A, according to aspects of the disclosure;

FIG. 1D is a perspective bottom-up view of the system of FIG. 1A, according to aspects of the disclosure;

FIG. 1E is a planar top-down view of the system of FIG. 1A, according to aspects of the disclosure;

FIG. 1F is a planar bottom-up view of the system of FIG. 1A, according to aspects of the disclosure;

FIG. 1G is a schematic diagram of an electronic assembly that is part of the system of FIG. 1A, according to aspects of the disclosure;

FIG. 1H is a schematic diagram of an electronic assembly that is part of the system of FIG. 1A, according to aspects of the disclosure;

FIG. 1I is a schematic diagram of an example of a sensor, according to aspects of the disclosure.

FIG. 1J is a schematic diagram showing the relative positioning of sensors that are part of the system of FIG. 1A, according to aspects of the disclosure.

FIG. 2A is a planar side view of an example of a system, according to aspects of the disclosure;

FIG. 2B is a planar side view of the system of FIG. 2A when viewed from a different angle, according to aspects of the disclosure;

FIG. 2C is a perspective top-down view of the system of FIG. 2A, according to aspects of the disclosure;

FIG. 2D is a perspective bottom-up view of the system of FIG. 2A, according to aspects of the disclosure;

FIG. 2E is a planar top-down view of the system of FIG. 2A, according to aspects of the disclosure;

FIG. 2F is a planar bottom-up view of the system of FIG. 2A, according to aspects of the disclosure;

FIG. 2G is a schematic diagram of an electronic assembly that is part of the system of FIG. 2A, according to aspects of the disclosure;

FIG. 2H is a schematic diagram of an electronic assembly that is part of the system of FIG. 2A, according to aspects of the disclosure;

FIG. 3A is a flowchart of an example of a process that is performed by the system of FIG. 1A, according to aspects of the disclosure;

FIG. 3B is a flowchart of an example of a process that is performed by the system of FIG. 2A, according to aspects of the disclosure;

FIG. 4 is a plot illustrating aspects of the operation of the system of FIG. 1A, according to aspects of the disclosure;

FIG. 5A is a perspective side view of an example of a system, according to aspects of the disclosure; and

FIG. 5B is a perspective side view of an example of a system, according to aspects of the disclosure.

### DETAILED DESCRIPTION

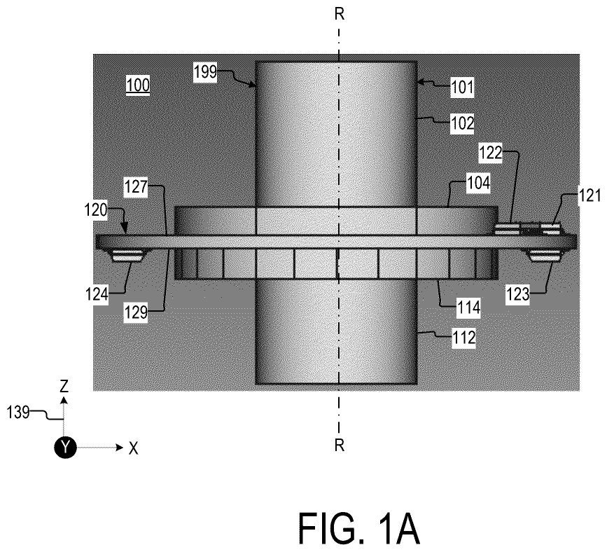

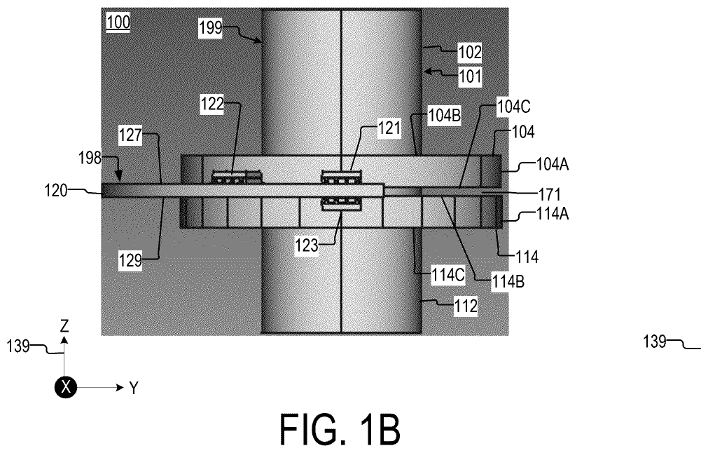

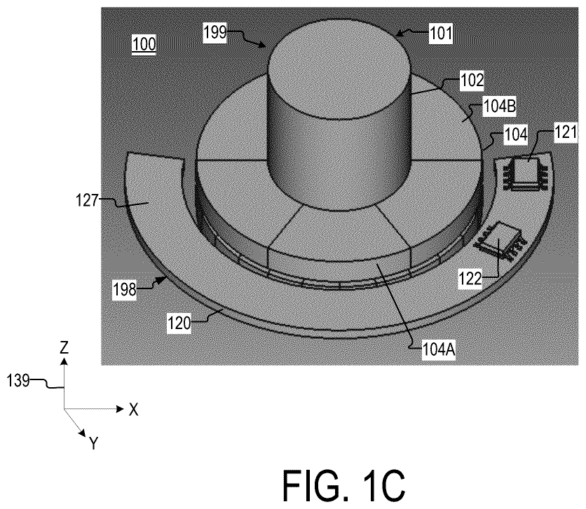

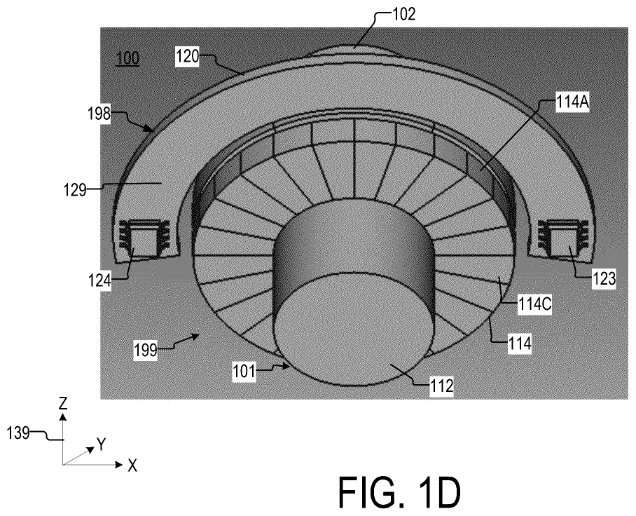

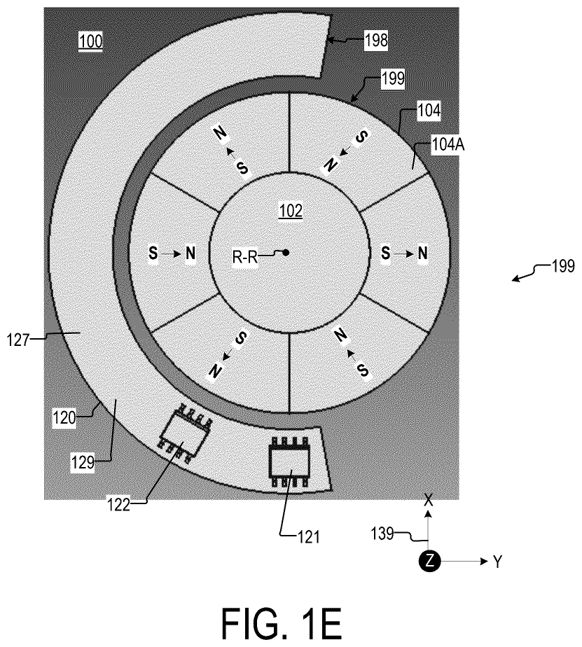

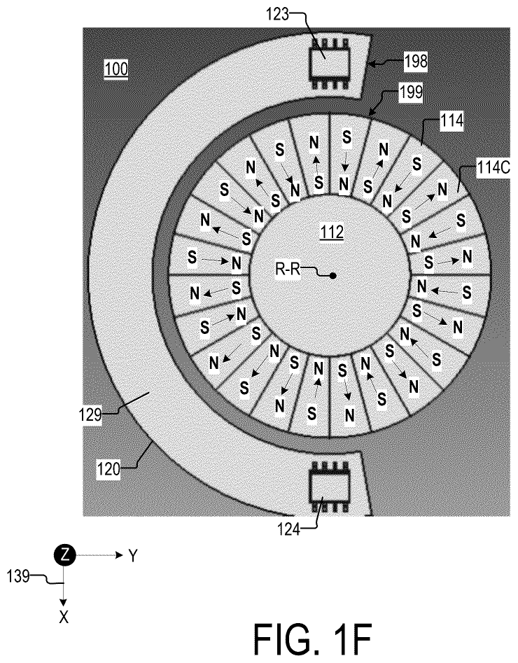

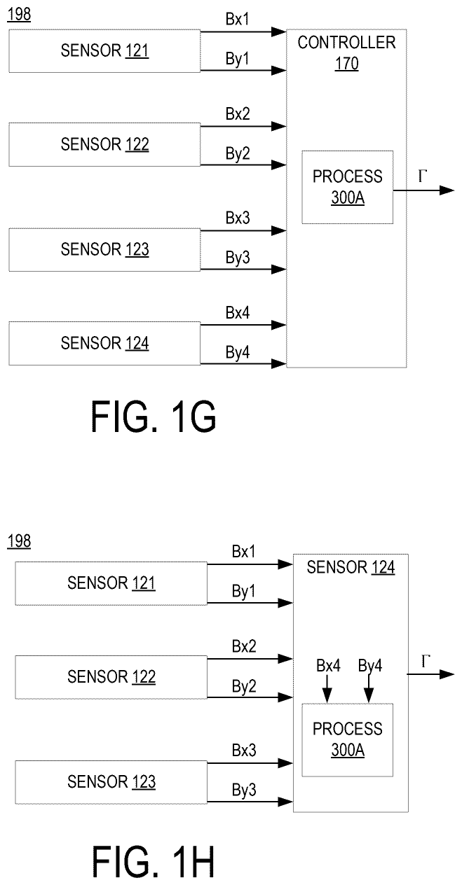

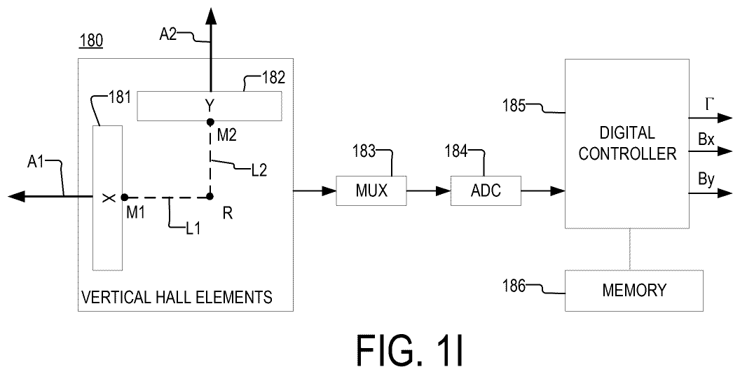

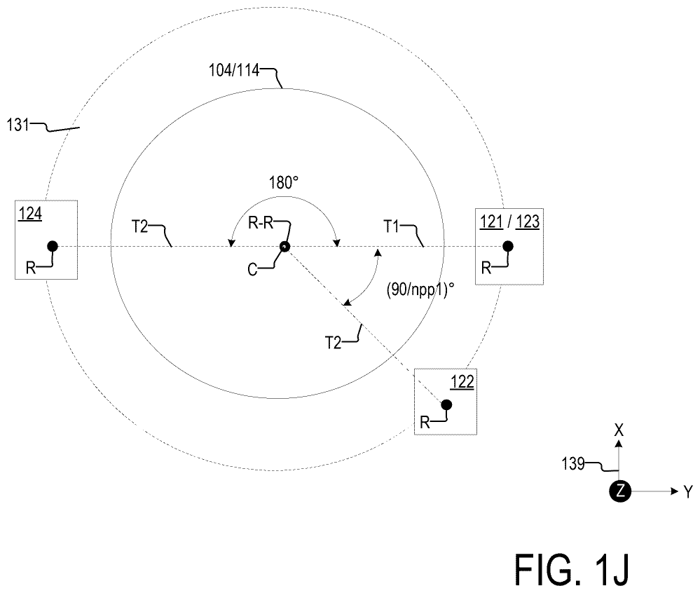

FIGS. 1A-J show an example of a system 100, according to aspects of the disclosure. As illustrated, the system 100 may include a mechanical assembly 199 and an electronic assembly 198. The mechanical assembly 199 may include a mechanical element 101, a ring magnet 104, and a ring magnet 114. The mechanical element 101 may include portions 102 and 112. Portions 102 and 112 may be integral with each other or they may be coupled to each other by any suitable type of mechanical coupling. Ring magnet 104 may be coupled to portion 102 and arranged to rotate with portion 102 when torque is applied to mechanical element 101. Ring magnet 114 may be coupled to portion 112 and arranged to rotate with portion 112 when torque is applied to mechanical element 101. Ring magnets 104 and 114 may be spaced apart from each other, such that a gap 171 (shown in FIG. 1B) is present between them. As illustrated in FIGS. 1B-D, ring magnet 104 may have a sidewall 104A that is disposed between a top wall 104B and a bottom wall 104C. Similarly, ring magnet 114 may have a sidewall 114A that is disposed between a top wall 114B and a bottom wall 114C.

Ring magnet 104 includes npp1 pole pairs, where npp1 is an odd integer greater than or equal to ‘3’ (i.e., npp1≥3). Ring magnet 114 includes npp2 pole pairs, where npp2 is an integer greater than npp1. In a preferred example, the value of npp2 is specified by equation 1 below:

$$npp 2 = 4 * m * npp 1 \qquad ( 1 )$$

where m is an integer greater than or equal to 1 (i.e., m≥1).

The electronic assembly 198 may include a printed circuit board (PCB) 120, magnetic field sensors 121, 122, 123, and 124, and optionally a controller 170 (shown in FIG. 1G). Magnetic field sensors 121, 122, 123, and 124, and optionally the controller 170, may be mounted on PCB 120. PCB 120 may have a main surface 127 and a main surface 129. Main surface 127 may be arranged to face portion 102 of mechanical element 101 and ring magnet 104. Main surface 129 may be arranged to face portion 112 of mechanical element 101 and ring magnet 114. Magnetic field sensors 121 and 122 may be disposed on main surface 127 and magnetic field sensors 123 and 124 may be disposed on main surface 129. Magnetic field sensor 121 may be disposed on the opposite side of PCB 120 from magnetic field sensor 123. For example, magnetic field sensor 121 may be disposed above or directly above magnetic field sensor 123, as shown. An example of the relative positioning of sensors 121-124 is shown in FIG. 1J. As illustrated in FIG. 1J, sensors 121-125 may be disposed (or centered) on a circle 131. As illustrated, sensors 121 and 122 may be disposed at an angle of approximately 90/npp1 degrees from each other. Additionally or alternatively, sensors 121 and 122 may be disposed at an angle of approximately 90/npp1 degrees from each other. Additionally or alternatively, in some implementations, the angle between sensors 121 and 122 may be slightly different from the angle between sensors 123 and 122. Additionally or alternatively, sensors 121 and 124 may be disposed at an angle of approximately 180 degrees. Additionally or alternatively, sensors 123 and 124 may be disposed at an angle of approximately 180 degrees. Additionally or alternatively, in some implementations, the angle between sensors 121 and 124 may be slightly different from the angle between sensors 123 and 124.

In some implementations, the PCB 120 may be inserted in the gap 171 (shown in FIG. 1B). Additionally or alternatively, in some implementations, PCB 120 may be disposed adjacent to the gap 171. Additionally alternatively, in some implementations, sensors 121 and 122 may be situated in greater proximity to target 104 than target 114, and sensors 123 and 124 may be situated in greater proximity to target 114 than target 104. Additionally or alternatively, in some implementations, all sensors 121-124 may be disposed on the same surface of PCB 120 (e.g., one of surfaces 127 and 129).

As used throughout the disclosure, the phrase “approximately X degrees” shall mean within +/−10 degrees of being exactly X degrees. In a preferred implementation, the angle between sensors 121/123 and sensor 124 is 180 degrees, and the angle between sensors 121/123 and sensor 122 is 90/npp1 degrees. The circle 131 is concentric with ring magnets 104/114. The circle 131 is provided to illustrate the curvature of a line (or path) on PCB 120 along which sensors 121, 122, 123, and 124 are positioned. Although, in the example of FIGS. 1A-J, the line has a circular curvature, alternative implementations are possible in which the curvature is an elliptical curvature or another type of curvature.

In one example, the angle between two sensors (e.g., 121 and 122) may be equal to the angle between a line T1 and a line T2, where line T1 extends from the reference point R of the first sensor to the center C of circle 131, and line T2 extends from the reference point R of the second sensor to the center C of circle 131. The definition of a reference point of a sensor is provided in the discussion with respect to FIG. 1I. Although, in the present example, the angular offset between any two of sensors 121-124 is defined in terms of those sensors' corresponding reference points, the present disclosure is not limited to any specific way for defining the reference frame for measuring the angular offset between any two of sensors 121-124. More broadly, the angular offset between two sensors (e.g., sensors 121 and 122) may be defined as the angle between two lines, where the first line extends between any point on the packaging of the first sensor and the center C of circle 131 (or the axis of rotation R-R) and the second line extends between any point on the packaging of the second sensor and the center C of circle 131 (or the axis of rotation R-R). According to the example of FIG. 1J, circle 131 rests in a plane that is parallel to the XY plane of coordinate system 139 and the center C of circle 131 lies on the axis of rotation R-R of ring magnets 104 and 114 (shown in FIG. 1A).

In the example of FIGS. 1A-J, the mechanical element 101 is a torsion bar. However, the present disclosure is not limited to the mechanical element 101 being any specific type of mechanical element. In the example of FIGS. 1A-J, the mechanical element 101 extends in parallel with the Z-axis of a coordinate system 139; and the main surfaces 127 and 129 of the PCB are parallel to the XY plane of the coordinate system 139. The top wall 104B and bottom wall 104C of the ring magnet 104 are parallel to the XY plane of coordinate system 139, and the sidewall 104A of the ring magnet 104 extends from the top wall 104B to the bottom wall 104C in a direction that is parallel to Z-axis of coordinate system 139. The top wall 114B and bottom wall 114C of the ring magnet 114 are parallel to the XY plane of coordinate system 139, and the sidewall 114A of the ring magnet 114 extends from the top wall 114B to the bottom wall 114C in a direction that is parallel to Z-axis of coordinate system 139.

When a twisting force (e.g., torque) is applied to mechanical element 101, portion 102 may rotate relative to portion 112. The amount of rotational displacement depends on the magnitude of the torque. As is discussed further below, the amount of torque that is being applied to mechanical element 101 is measured by electronic assembly 198.

According to the example, when torque (i.e., twisting force) is applied to mechanical element 101, ring magnets 104 and 114 may rotate (in the opposite directions or in the same direction but at a slower rate) about an axis R-R (shown in FIGS. 1A, 1E, and 1F). According to the present example, the axis R-R is parallel to the Z-axis of the coordinate system 139. According to the present example, axis R-R is coincident with the central longitudinal axis (not shown) of mechanical element 101. However, in alternative implementations the axis R-R may be offset or at a slight angle from the central longitudinal axis of mechanical element 101. As is discussed further below, the electronic assembly 198 may measure the relative rotation of ring magnets 104 and 114 and use is at as a proxy for torque.

FIG. 1I shows a schematic diagram of a sensor 180. Sensor 180 may be the same or similar to each of sensors 121-124. FIG. 1I is provided to illustrate one possible implementation of sensors 121-124. However, the present disclosure is not limited to any specific implementation of sensors 121-124. In the example of FIG. 1I, sensor 180 includes vertical Hall elements 181 and 182, a multiplexer 183, an analog-to-digital converter (ADC) 184, a digital controller 185, and a memory 186. The multiplexer 183 may be configured to select between a first signal that is generated by Hall element 181 and a second signal that is generated by Hall element 182 and route the selected signal to ADC 184. ADC 184 may digitize the selected signal and provide the digitized signal to controller 185.

The controller 185 may include any suitable type of processing circuitry. By way of example, the controller may include a general-purpose processor, a special-purpose processor, a CORDIC processor, and/or any other suitable type of processing circuitry. The memory 186 may include any suitable type of volatile and/or non-volatile memory. In one example, memory 186 may include flash memory, Dynamic Random Access Memory (DRAM), and/or any other suitable type of memory.

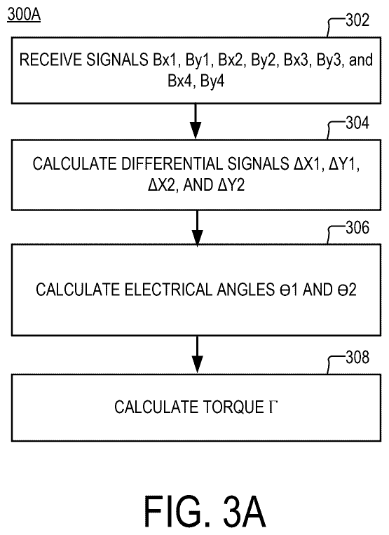

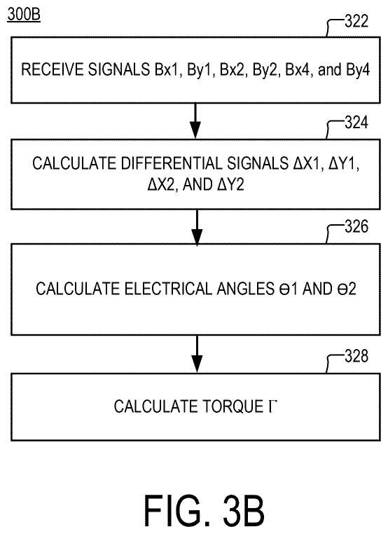

In some implementations, the controller 185 may be configured to generate a signal Bx. Signal Bx may be identical to or otherwise based on the output of sensing element 181. In one example, signal Bx may be generated by filtering the output of sensing element 181. Additionally or alternatively, signal Bx may be generated by performing gain and/or offset adjustment on the output of sensing element 181. Additionally or alternatively, the controller 185 may be configured to generate a signal By. Signal may be identical to or otherwise based on the output of sensing element 182. In one example, signal By may be generated by filtering the output of sensing element 182. Additionally or alternatively, signal By may be generated by performing gain and/or offset adjustment on the output of sensing element 182. Additionally or alternatively, in some implementations, the controller 185 may output a signal Γ that is indicative of the torque that is being applied to a mechanical element, such as the mechanical element 101. The signal Γ may be generated in accordance with a process 300A, which is discussed further below with respect to FIG. 3A. In some implementations, the sensor 180 and/or controller 185 may lack the capability to generate the signal Γ. In some implementations, any of signals Bx, By, and Γ may be output to external circuitry from an output interface (not shown) of the sensor 180. According to the present example, Hall elements 181 and 182 have axes of maximum sensitivity that are substantially perpendicular to each other. For example, Hall element 181 may have an axis of maximum sensitivity A1, and Hall element 182 may have an axis of maximum sensitivity A2 that is substantially perpendicular to axis A1. As used herein, the phrase “substantially perpendicular” shall mean “within +/−10 degrees of being exactly perpendicular”.

According to aspects of the disclosure, FIG. 1I is provided to illustrate one possible implementation of sensors 121-124. However, the present disclosure is not limited to any specific implementation of sensors 121-124. In implementations in which each of sensors 121-124 is provided with a pair of vertical Hall elements whose axes of maximum sensitivity are substantially perpendicular, each of sensors 121-122 may be oriented in a way that causes: (i) the axis of maximum sensitivity of one of the vertical Hall elements in the sensor to point to the central axis of ring magnets 104/114 (or the axis of rotation R-R), and (ii) the axis of maximum sensitivity of the other one of the vertical Hall elements in the sensor to point in a direction that is tangential to the circumference of ring magnet 104/114.

In the example of FIG. 1I, Hall element 181 has a midpoint M1, Hall element 182 has a midpoint M2, and sensor 180 has a reference point R, where a line L1 extends between reference point R and the midpoint L1 and line L2 extends between reference point R midpoint M2. According to the present example, line L1 is substantially perpendicular to line L2, line L1 is substantially parallel to the axis of maximum sensitivity A1 of Hall element 181, and line L2 is substantially parallel to the axis of maximum sensitivity A2 of Hall element 181. As used throughout the disclosure, the phrase “substantially perpendicular” shall mean within +/−10 degrees of being exactly perpendicular. As used throughout the disclosure, the phrase “substantially parallel” shall mean within +/−10 degrees of being exactly parallel.

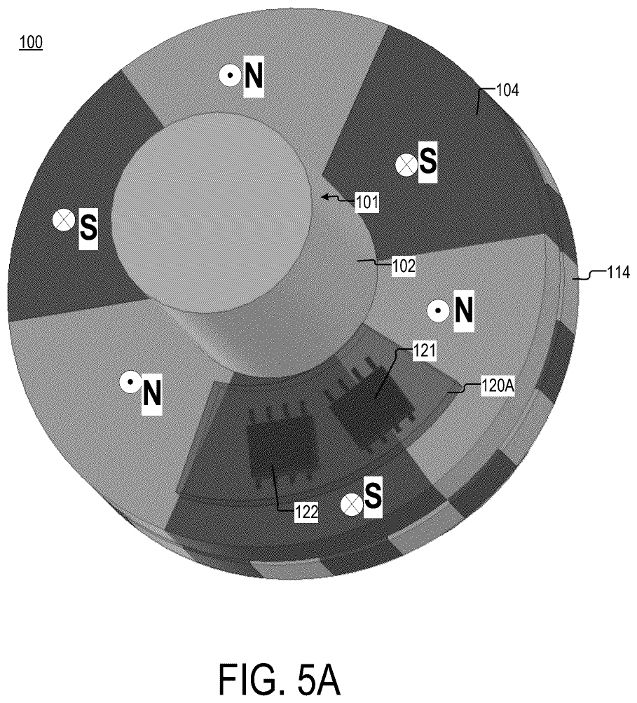

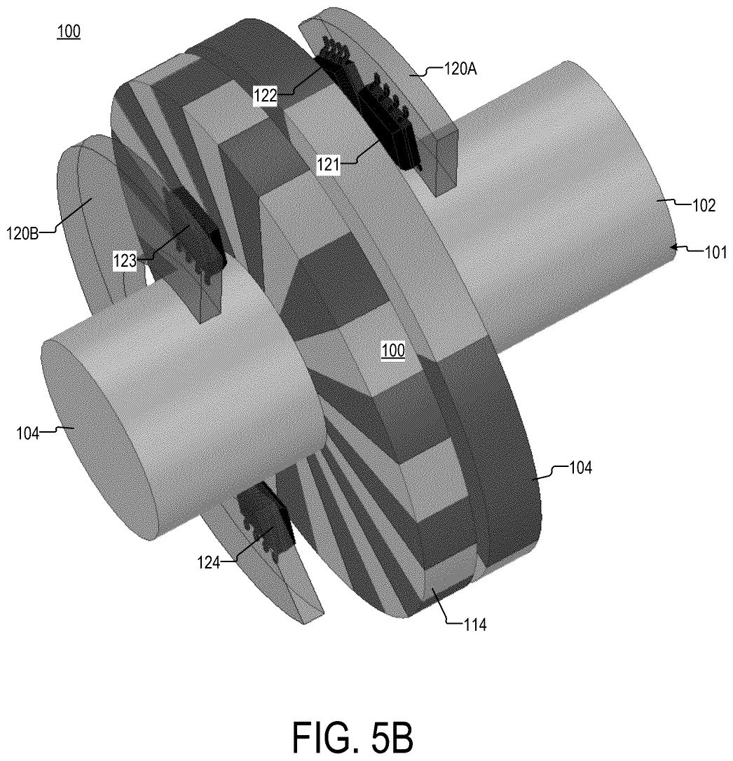

In the example of FIGS. 1A-J, ring magnets 104 and 114 have radial magnetization. However, alternative implementations are possible in which ring magnets 104 and 114 have axial magnetization, along +/−z axis. FIGS. 5A-B shows the configuration of system 100 when ring magnets 104 and 114 have axial magnetization. FIG. 5A shows that when ring magnets 104 and 114 have axial magnetization, sensors 121 and 122 may be disposed above ring magnet 104 and sensors 123 and 124 may be disposed below ring magnet 114. The relative angles between sensors 121, 122, 123, and 124 remain the same (i.e., 90/npp1 and 180). Sensors 121 and 122 may be mounted on a PCB 120A and sensors 123 and 124 are mounted on a PCB 120B. PCBs 120A and 120B may be electrically coupled to each other and their combined functionality may be the same to that of PCB 120. In the example of FIGS. 5A-B, in some implementations, sensors 121-124 may use planar Hall elements, rather than vertical Hall elements. In some implementations one of the ring magnets 104 and 114 can have axial magnetization and the other may have a redial magnetization.

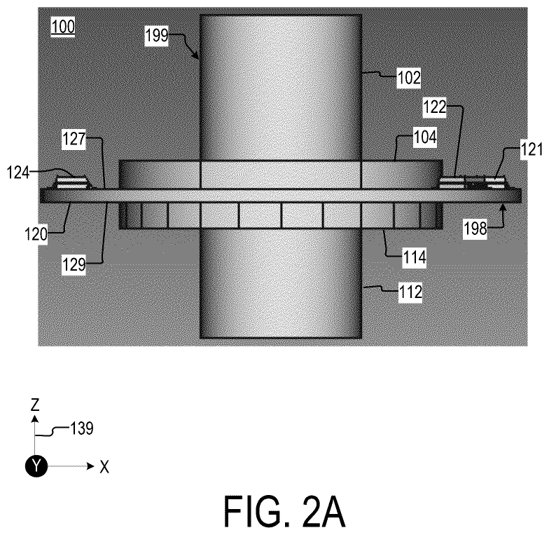

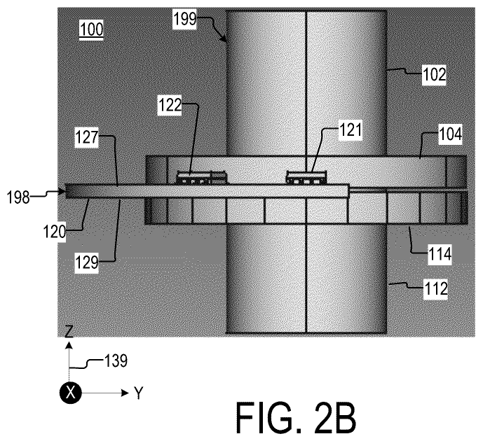

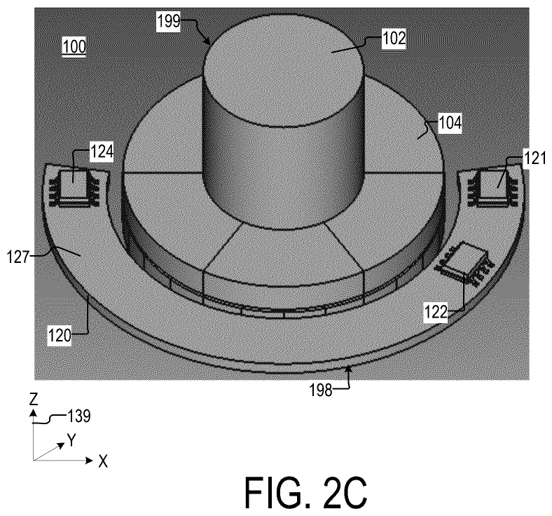

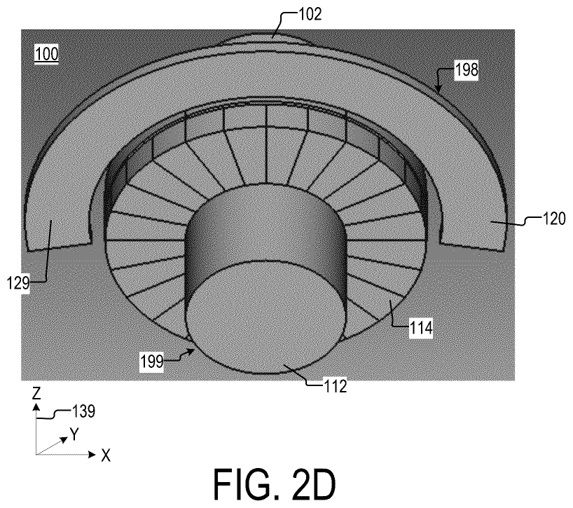

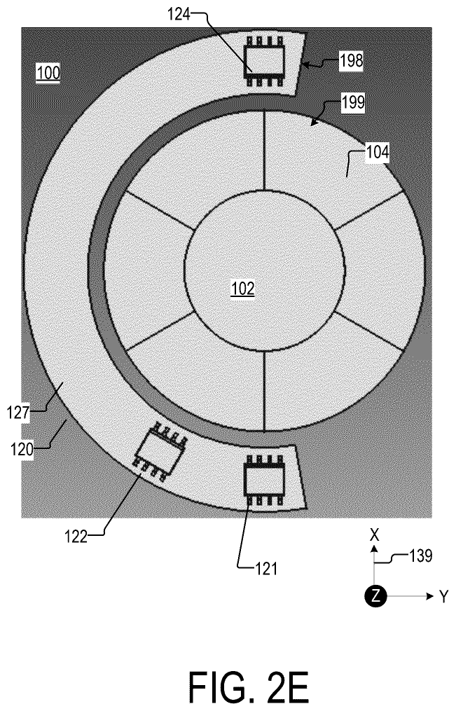

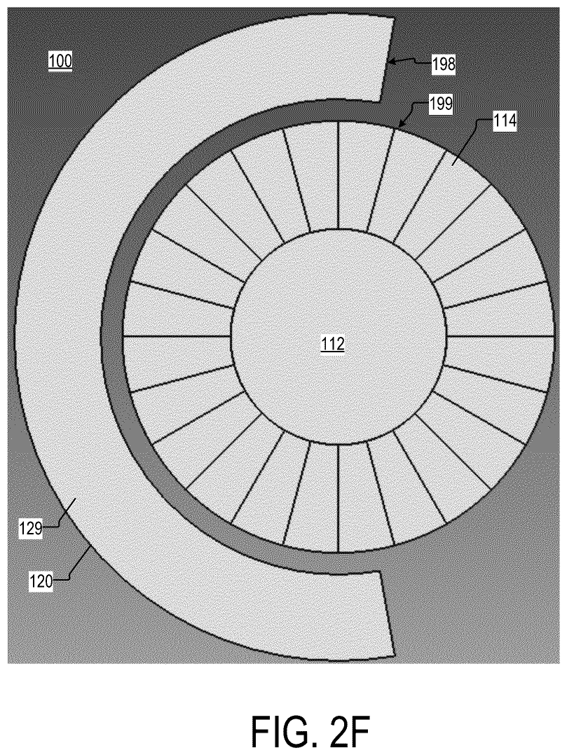

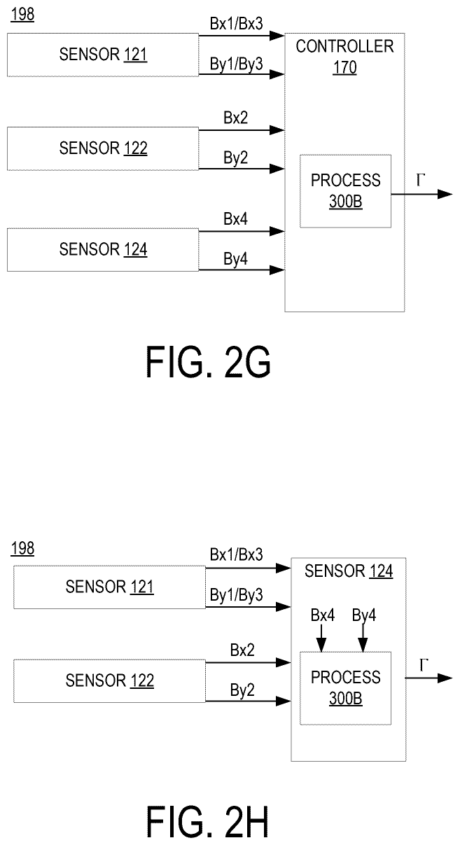

According to the present disclosure, sensor 121 may be configured to generate signals Bx1 and By1. Signal Bx1 may be indicative of the radial magnetic field of ring magnets 104/114, as measured by sensor 121. Signal By1 may be indicative of the tangential magnetic field of ring magnets 104/114, as measured by sensor 121. Sensor 122 may be configured to generate signals Bx2 and By2. Signal Bx2 may be indicative of the radial magnetic field of ring magnets 104/114, as measured by sensor 122. Signal By2 may be indicative of the tangential magnetic field of ring magnets 104/114, as measured by sensor 122. Sensor 123 may be configured to generate signals Bx3 and By3 are generated by sensor 123. Signal Bx3 may be indicative of the radial magnetic field of ring magnets 104/114, as measured by sensor 123. Signal By3 may be indicative of the tangential magnetic field of ring magnets 104/114, as measured by sensor 123. Sensor 124 may be configured to generate signals Bx4 and By4. Signal Bx4 may be indicative of the radial magnetic field of ring magnets 104/114, as measured by sensor 124. Signal By4 may be indicative of the tangential magnetic field of ring magnets 104/114, as measured by sensor 124. Examples of systems and methods that use signals Bx1, Bx2, Bx3, Bx4, By1, By2, By3, and By4 are discussed further below with respect to FIGS. 1G-H, FIGS. 2G-H, and FIGS. 3A-B.

The above example assumes that magnets 104 and 114 are radially magnetized. On the other hand, when ring magnets 104 and 114 are axially magnetized, signal Bx1 may be indicative of the axial magnetic field of ring magnets 104/114, as measured by sensor 121. Signal By1 may be indicative of the tangential magnetic field of ring magnets 104/114, as measured by sensor 121. Signal Bx2 may be indicative of the axial magnetic field of ring magnets 104/114, as measured by sensor 122. Signal By2 may be indicative of the tangential ring magnets 104/114, as measured by sensor 122. Signal Bx3 may be indicative of the axial magnetic field of ring magnets 104/114, as measured by sensor 123. Signal By3 may be indicative of the tangential magnetic field of ring magnets 104/114, as measured by sensor 123. Signal Bx4 may be indicative of the axial magnetic field of ring magnets 104/114, as measured by sensor 124. Signal By4 may be indicative of the tangential magnetic field of ring magnets 104/114, as measured by sensor 124.

In general, signals Bx and By that are generated by any of sensors 121-124 may be approximately 90 degrees off-phase from each other. For example, signals Bx1 and By1 may be approximately 90 degrees off-phase from each other, signals Bx2 and By2 may be approximately 90 degrees off-phase from each other, signals Bx3 and By3 may be approximately 90 degrees off-phase from each other, and signals Bx4 and By4 may be approximately 90 degrees off-phase from each other. Although, in the present example, those signals are generated by using vertical Hall elements, it will be understood that the present disclosure is not limited to using any specific type of magnetic field sensing element. For example, in some implementations, horizontal Hall elements, giant magnetoresistance (GMR) elements or tunneling magnetoresistance (TMR) elements may be used instead of vertical Hall elements

FIG. 1G shows an example of one implementation of electronic assembly 198. In the example of FIG. 1G, electronic assembly 198 includes a controller 170. Controller 170 may include a general-purpose processor, a special-purpose processor, and/or any other suitable type of processing circuitry. The controller may be configured to receive signs Bx1, By1, Bx2, By2, Bx3, By3, Bx4, and By4 and generate a signal Γ. The signal Γ may be indicative of the torque that is incident on mechanical element 101. The signal Γ may be generated based on Bx1, By1, Bx2, By2, Bx3, By3, Bx4, and By4. The signal Γ may be generated by executing a process 300A, which is discussed further below with respect to FIG. 3A.

FIG. 1H shows an example of another implementation of electronic assembly 198. In the example of FIG. 1G, electronic assembly 198 lacks a separate controller and instead uses the internal controller of sensor 124 to generate signal r. As noted above, the signal Γ may be indicative of the torque that is incident on mechanical element 101. The signal Γ may be generated based on signals Bx1, By1, Bx2, By2, Bx3, By3, Bx4, and By4. The signal Γ may be generated by executing the process 300A, which is discussed further below with respect to FIG. 3A.

FIG. 2A-H show an example of an alternative implementation of system 100, according to aspects of the disclosure. In the implementation of FIGS. 2A-H, sensor 123 is not present in electronic assembly 198, and the signal Γ is generated by using a process 300B, which is discussed further below with respect to FIG. 3B. The process 300B uses the output of sensor 121 as a substitute for the output of sensor 123. Moreover, in the example of FIGS. 2A-J, sensor 124 is disposed on the main surface 127 of PCB 120. However, sensor 124 may be on the opposite surface (i.e., main surface 129), as well. The angle between sensor 124 and sensor 121 is still approximately 180 degrees (as indicated in FIG. 1J). Apart from these differences, the example of FIGS. 2A-H is identical to the example of FIGS. 1A-J.

FIG. 2G shows an example of an implementation of electronic assembly 198 in which sensor 123 is omitted. In the example of FIG. 2G, electronic assembly 198 includes sensor 121, sensor 122, sensor 124, and the controller 170. The controller 170 may be configured to receive signs Bx1, By1, Bx2, By2, Bx4, and By4 and generate signal Γ based on those signals. In the example of FIG. 2G, signal Γ is generated by executing a process 300B, which is discussed further below with respect to FIG. 3B.

FIG. 2H shows an example of another implementation of electronic assembly 198 in which sensor 123 is omitted. In the example of FIG. 1G, electronic assembly 198 lacks a separate controller and instead uses the internal controller of sensor 124 to generate signal r. As noted above, the signal Γ may be indicative of the torque that is incident on mechanical element 101. The signal Γ may be generated based on signals Bx1, By1, Bx2, By2, Bx4, and By4. The signal Γ may be generated by executing the process 300B, which is discussed further below with respect to FIG. 3B.

FIG. 3A shows an example of a process 300A, according to aspects of the disclosure. As noted above, process 300A may be performed by controller 170 (shown in FIG. 1G), the internal controller of any of sensors 121-124, or by a processor that is external to electronic assembly 198. Stated succinctly, the present disclosure is not limited to any specific entity executing process 300A.

At step 302, signals Bx1, By1, Bx2, By2, Bx3, By3, Bx4, and By4 are received. As noted above, signals Bx1 and By1 are generated by sensor 121; signals Bx2 and By2 are generated by sensor 122; signals Bx3 and By3 are generated by sensor 123; and signals Bx4 and By4 are generated by sensor 124.

At step 304, differential signals ΔX1, ΔX1, ΔX2, and ΔY2 are generated based on the signals received at step 302. Differential signal ΔX1 may include any signal that is at least in part based on the difference between signals Bx1 and Bx2. Differential signal ΔX2 may include any signal that is at least in part based on the difference between signals Bx3 and Bx4. Differential signal ΔY1 may include any signal that is at least in part based on the difference between signals By1 and By2. Differential signal ΔY2 may include any signal that is at least in part based on the difference between signals By3 and By4. In one implementation, signals ΔX1, ΔY1, ΔX2, and ΔY2 may be generated in accordance with equations 2-5 below:

$$Δ X 1 = Bx 1 - Bx 2 \qquad ( 2 )$$

$$Δ Y 1 = By 1 - By 2 \qquad ( 3 )$$

$$Δ X 2 = Bx 3 - Bx 4 \qquad ( 4 )$$

$$Δ Y 2 = By 3 - By 4 \qquad ( 5 )$$

At step 306, a first angle value Θ1 and a second angle value Θ2 are generated. The first angle value Θ1 is generated based on differential signals ΔX1, ΔY1, and the count npp1 of magnetic pole pairs in ring magnet 104. The second angle value Θ2 is generated based on differential signals ΔX2, ΔY2, and the count npp2 of magnetic pole pairs in ring magnet 114. As can be readily appreciated, the first angle value Θ1 and the second angle value Θ2 may also be referred to as “mechanical angles”. In one example, the first angle value Θ1 and the second angle value Θ2 may be generated in accordance with equations 6 and 7 below:

$$Θ 1 = \frac{atan 2 ( Δ Y 1 , Δ X 1 )}{npp 1} \qquad ( 6 )$$

$$Θ 2 = \frac{atan 2 ( Δ Y 2 , Δ X 2 )}{npp 2} \qquad ( 7 )$$

At step 308, a signal Γ is calculated. As noted above, the signal Γ may be any signal that is at least in part indicative of the torque (i.e., twisting force) that is being applied on mechanical element 101. The signal Γ may be any signal that is at least in part based on the difference first angle value Θ1 and the second angle value Θ2. In one example, the signal Γ may be calculated based on equation 8 below:

$$Γ = k \times ( Θ 1 - Θ 2 ) \qquad ( 8 )$$

where k is a constant greater than zero (i.e., k>0). The value of constant k may depend on the flexibility and/or mechanical characteristics of mechanical assembly 199 and it may vary depending on the application. Those of ordinary skill in the art will readily recognize, after reading the present disclosure, how to determine the value of constant k. In some implementations, the value of constant k may be determined experimentally. Furthermore, in some implementations, the value of constant k may be equal to 1.

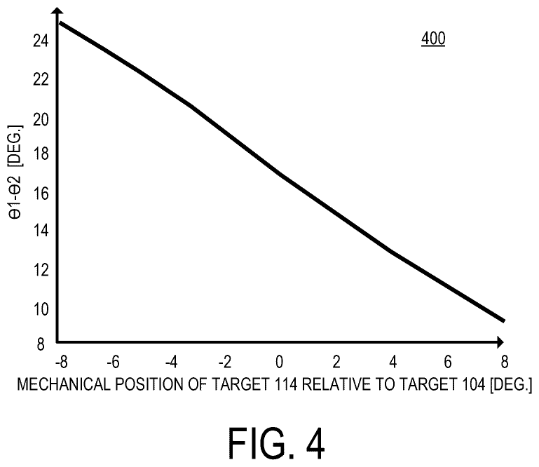

FIG. 4 shows a plot 400, which illustrates the relationship between the difference between the first angle value Θ1 and the second angle value Θ2 and the mechanical position of ring magnet 104 relative to ring magnet 114. Plot 400 was generated as a result of simulating the system 100 with the MATLAB software. The magnetic fields of ring magnets 104 and 114 were simulated versus the relative angle between the ring magnets; the values of Θ1 and Θ2 were calculated based on the outcome of the simulation. The simulation assumed that: (i) the number of pole pairs in ring magnet 104 is equal to 3 (i.e., npp1=3) and (ii) the number of pole pairs in ring magnet 114 is equal to 12 (i.e., npp2=12). According to the example of FIG. 4, ring magnet 114 is situated at mechanical position of 0° when no torque (i.e., twisting force) is being applied on mechanical element 101. Furthermore, according to the example of FIG. 4, ring magnet 104 is situated at mechanical position of 1° when no torque (i.e., twisting force) is being applied on mechanical element 101. The X-axis of plot 400 corresponds to the actual angular offset between ring magnets 104 and 114. The Y-axis of plot 400 corresponds to the difference between angle values Θ1 and Θ2. Plot 400 illustrates that the relationship between the difference between angle values Θ1 and Θ2 and the actual angular offset between ring magnets 104 and 114 is almost linear, which makes the difference between angle values Θ1 and Θ2 a highly suitable vehicle for estimating the torque (i.e., twisting force) that is incident on mechanical element 101. In some implementations, the value of constant k, which is used in equations 8 and 15, may be selected to equalize the slope of the linear relationship to ‘1’.

According to aspects of the disclosure, process 300A takes advantage of the positioning of sensors 121-124 relative to each other, and relative to ring magnets 104 and 114. This positioning causes the influence of ring magnet 104 on differential signals ΔX2 and ΔY2 to be canceled. Furthermore, the positioning causes the influence of ring magnet 114 on differential signals ΔX1 and ΔY1 to be canceled.

According to aspects of the disclosure, in the example of FIGS. 1A-J, signals ΔX2 and ΔY2 are fully differential. More specifically, positioning sensors 123 and 124 at a 180-degree angle relative to each other results in the same stray field, which is incident on sensors 123 and 124, being rejected in the calculation of signals ΔX2 and ΔY2. However, this assumes that the linear distance between sensors 123 and 124 is sufficiently small. If the distance between sensors 123 and 124 is larger, the rejection of the stray field may be incomplete, which in turn could compromise to a certain extent the accuracy of signal T. As can be readily appreciated, the distance between sensors 123 and 124 would vary depending on the application, and it can be readily determined by those of ordinary skilled in the art, after reading the present disclosure.

According to aspects of the disclosure, in the example of FIGS. 1A-J, signals ΔX1 and ΔY1 are substantially, but not completely, differential. More specifically, positioning sensors 121 and 122 at an angle of 90/npp1 degrees relative to each other results in the same stray field, which is incident on sensors 121 and 122, being rejected in the calculation of signals ΔX1 and ΔY1. However, this assumes that the linear distance between sensors 121 and 122 is sufficiently small. If the distance between sensors 121 and 122 is larger, the rejection of the stray field may be incomplete, which in turn could compromise to a certain extent the accuracy of signal T. As can be readily appreciated, the distance between sensors 121 and 122 would vary depending on the application, and it can be readily determined by those of ordinary skilled in the art, after reading the present disclosure. As used herein, the term “substantially differential means” within +/−10% of being differential.

FIG. 3B shows an example of a process 300B, according to aspects of the disclosure. As noted above, process 300B may be performed by controller 170 (shown in FIG. 2G), the internal controller of any of sensors 121-124, or by a processor that is external to electronic assembly 198. Stated succinctly, the present disclosure is not limited to any specific entity executing process 300B. Process 300B is nearly identical to process 300A, except that it uses signals Bx1 and By1 as a substitute for signals Bx3 and By3. Process 300B may be utilized when sensor 123 is omitted from electronic assembly 198. It will be recalled that, under the nomenclature of the present disclosure, Bx3 and By3 are the signals generated by sensor 123.

At step 322, signals Bx1, By1, Bx2, By2, Bx4, and By4 are received. As noted above, signals Bx1 and By1 are generated by sensor 121; signals Bx2 and By2 are generated by sensor 122; and signals Bx4 and By4 are generated by sensor 124.

At step 324, differential signals ΔX1, ΔY1, ΔX2, and ΔY2 are generated based on the signals received at step 302. Differential signal ΔX1 may include any signal that is at least in part based on the difference between signals Bx1 and Bx2. Differential signal ΔX2 may include any signal that is at least in part based on the difference between signals Bx1 and Bx4. Differential signal ΔY1 may include any signal that is at least in part based on the difference between signals By1 and By2. Differential signal ΔY2 may include any signal that is at least in part based on the difference between signals By1 and By4. In one implementation, signals ΔX1, ΔY1, ΔX2, and ΔY2 may be generated in accordance with equations 9-12 below:

$$Δ X 1 = Bx 1 - Bx 2 \qquad ( 9 )$$

$$Δ Y 1 = By 1 - By 2 \qquad ( 10 )$$

$$Δ X 2 = Bx 1 - Bx 4 \qquad ( 11 )$$

$$Δ Y 2 = By 1 - By 4 \qquad ( 12 )$$

At step 326, a first angle value Θ1 and a second angle value Θ2 are generated. The first angle value Θ1 is generated based on differential signals ΔX1, ΔY1, and the count npp1 of magnetic pole pairs in ring magnet 104. The second angle value Θ2 is generated based on differential signals ΔX2, ΔY2, and the count npp2 of magnetic pole pairs in ring magnet 114. As can be readily appreciated, the first angle value Θ1 and the second angle value Θ2 may also be referred to as “mechanical angles”. In one example, the first angle value Θ1 and the second angle value Θ2 may be generated in accordance with equations 13 and 14 below:

$$Θ 1 = \frac{atan 2 ( Δ Y 1 , Δ X 1 )}{npp 1} \qquad ( 13 )$$

$$Θ 2 = \frac{atan 2 ( Δ Y 2 , Δ X 2 )}{npp 2} \qquad ( 14 )$$

At step 328, a signal Γ is calculated. As noted above, the signal Γ may be any signal that is at least in part indicative of the torque (i.e., twisting force) that is being applied on mechanical element 101. The signal Γ may be any signal that is at least in part based on the difference first angle value Θ1 and the second angle value Θ2. In one example, the signal Γ may be calculated based on equation 15 below:

$$Γ = k \times ( Θ 1 - Θ 2 ) \qquad ( 15 )$$

where k is a constant greater than zero (i.e., k>0).

The concepts and ideas described herein may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers). Each such program may be implemented in a high-level procedural or object-oriented programming language to work with the rest of the computer-based system. However, the programs may be implemented in assembly, machine language, or Hardware Description Language. The language may be a compiled or an interpreted language, and it may be deployed in any form, including as a stand-alone program or as a module, component, subroutine, or another unit suitable for use in a computing environment. A computer program may be deployed to be executed on one computer or multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, or volatile memory. The term unit (e.g., an addition unit, a multiplication unit, etc.), as used throughout the disclosure may refer to hardware (e.g., an electronic circuit) that is configured to perform a function (e.g., addition or multiplication, etc.), software that is executed by at least one processor, and configured to perform the function, or a combination of hardware and software.

According to the present disclosure, a magnetic field sensing element can include one or more magnetic field sensing elements, such as Hall effect elements, magnetoresistance elements, or magnetoresistors, and can include one or more such elements of the same or different types. As is known, there are different types of Hall effect elements, for example, a planar Hall element, a vertical Hall element, a fluxgate, and a Circular Vertical Hall (CVH) element. As is also known, there are different types of magnetoresistance elements, for example, a semiconductor magnetoresistance element such as Indium Antimonide (InSb), a giant magnetoresistance (GMR) element, for example, a spin valve, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims.

1. A system, comprising:
a ring magnet that is coupled to a first portion of a mechanical element, the first portion extending in a first direction, the first ring magnet having npp1 pole pairs, where npp1 is an odd integer, and npp1≥3;
a second ring magnet that is coupled to a second portion of a mechanical element, the second portion extending in a second direction that is opposite to the first direction, the second ring magnet having npp2 pole pairs, where npp2=4*m*npp2, m is an integer, and m≥1;
first and second magnetic field sensor, the first and second magnetic field sensors being disposed at an angle of approximately 90/npp1 degrees relative to each other; and
third and fourth magnetic field sensors, the third and fourth magnetic field sensors being disposed at an angle of approximately 180 degrees relative to each other.

2. The system of claim 1, wherein the third magnetic field sensor is disposed directly under or directly above the first magnetic field sensor.

3. The system of claim 1, wherein the first ring magnet has one of a radial or axial magnetization, and the second ring magnet has the same magnetization as the first ring magnet.

4. The system of claim 1, wherein the first ring magnet has axial magnetization and the second ring magnet has radial magnetization.

5. The system of claim 1, wherein the first ring magnet has radial magnetization and the second ring magnet has axial magnetization.

6. The system of claim 1, wherein:
the first and second magnetic field sensors are situated in greater proximity to the first ring magnet than the third and fourth magnetic field sensors, and
the third and fourth magnetic field sensors are situated in greater proximity to the second ring magnet than the first and second magnetic field sensors.

7. The system of claim 1, wherein:
the first magnetic field sensor is configured to generate signals Bx1 and By1, the signal Bx1 being indicative of a strength of a radial or axial magnetic field that is measured by the first magnetic field sensor, and the signal By1 being indicative of a strength of a tangential magnetic field that is measured by the first magnetic field sensor;
the second magnetic field sensor is configured to generate signals Bx2 and By2, the signal Bx2 being indicative of a strength of a radial or axial magnetic field that is measured by the second magnetic field sensor, and the signal By2 being indicative of a strength of a tangential magnetic field that is measured by the second magnetic field sensor;
the third magnetic field sensor is configured to generate signals Bx3 and By3, the signal Bx3 being indicative of a strength of a radial or axial magnetic field that is measured by the third magnetic field sensor, and the signal By3 being indicative of a strength of a tangential magnetic field that is measured by the third magnetic field sensor; and
the fourth magnetic field sensor is configured to generate signals Bx4 and By4, the signal Bx4 being indicative of a strength of a radial or axial magnetic field that is measured by the fourth magnetic field sensor, and the signal By4 being indicative of a strength of a tangential magnetic field that is measured by the fourth magnetic field sensor.

8. The system of claim 7, wherein a given one of the first, second, third, and fourth magnetic field sensors is configured to:
calculate a first angle value based on signals Bx1, Bx2, By1, By2, and npp1;
calculate a second angle value based on signals Bx3, Bx4, By3, By4, and npp2; and
generate an indication of torque that is incident on the mechanical element based on the first angle value and the second angle value.

9. The system of claim 8 wherein:
the first angle value is generated based on a difference between signals Bx1 and Bx2 and a difference between signals By1 and By2;
the second angle value is generated based on a difference between signals Bx3 and Bx4 and a difference between signals By3 and By4.

10. The system of claim 7, further comprising a controller that is configured to:
calculate a first angle value based on signals Bx1, Bx2, By1, By2, and npp1;
calculate a second angle value based on signals Bx3, Bx4, By3, By4, and npp2; and
generate an indication of torque that is incident on the mechanical element based on the first angle value and the second angle value.

11. The system of claim 10, wherein:
the first angle value is generated based on a difference between signals Bx1 and Bx2 and a difference between signals By1 and By2;
the second angle value is generated based on a difference between signals Bx3 and Bx4 and a difference between signals By3 and By4.

12. The system of claim 1, wherein the mechanical element includes a torsion bar.

13. A system, comprising:
a ring magnet that is coupled to a first portion of a mechanical element, the first portion extending in a first direction, the first ring magnet having npp1 pole pairs, where npp1 is an odd integer, and npp1≥3;
a second ring magnet that is coupled to a second portion of a mechanical element, the second portion extending in a second direction that is opposite to the second direction, the second ring magnet having npp2 pole pairs, where npp2=4*m*npp2, m is an integer, and m≥1;
a first and second magnetic field sensor, the first and second magnetic field sensors being disposed at an angle of approximately 90/npp1 degrees relative to each other; and
a third magnetic field sensor (124), the first and third magnetic field sensors being disposed at an angle of approximately 180 degrees relative to each other.

14. The system of claim 13, wherein the first, second, and third magnetic field sensors are situated around a perimeter of the first ring magnet.

15. The system of claim 13, wherein the first ring magnet has one of a radial or axial magnetization, and the second ring magnet has the same magnetization as the first ring magnet.

16. The system of claim 13, wherein the first ring magnet has axial magnetization and the second ring magnet has radial magnetization.

17. The system of claim 13, wherein the first ring magnet has radial magnetization and the second ring magnet has axial magnetization.

18. The system of claim 13, wherein the first, second, and third magnetic field sensors are situated in greater proximity to the first ring magnet than to the second ring magnet.

19. The system of claim 13, wherein:
the first magnetic field sensor is configured to generate signals Bx1 and By1, the signal Bx1 being indicative of a strength of a radial or axial magnetic field that is measured by the first magnetic field sensor, and the signal By1 being indicative of a strength of a tangential magnetic field that is measured by the first magnetic field sensor;
the second magnetic field sensor is configured to generate signals Bx2 and By2, the signal Bx2 being indicative of a strength of a radial or axial magnetic field that is measured by the second magnetic field sensor, and the signal By2 being indicative of a strength of a tangential magnetic field that is measured by the second magnetic field sensor;
the third magnetic field sensor is configured to generate signals Bx4 and By4, the signal Bx4 being indicative of a strength of a radial or axial magnetic field that is measured by the third magnetic field sensor, and the signal By4 being indicative of a strength of a tangential magnetic field that is measured by the third magnetic field sensor.

20. The system of claim 19, wherein a given one of the first, second, third, and third magnetic field sensors is configured to:
calculate a first angle value based on signals Bx1, Bx2, By1, By2, and npp1;
calculate a second angle value based on signals Bx1, Bx4, By1, By4, and npp2; and
generate an indication of torque that is incident on the mechanical element based on the first angle value and the second angle value.

21. The system of claim 20, wherein:
the first angle value is generated based on a difference between signals Bx1 and Bx2 and a difference between signals By1 and By2;
the second angle value is generated based on a difference between signals Bx1 and Bx4 and a difference between signals By1 and By4.

22. The system of claim 19, further comprising a controller that is configured to:
calculate a first angle value based on signals Bx1, Bx2, By1, By2, and npp1;
calculate a second angle value based on signals Bx1, Bx4, By1, By4, and npp2; and
generate an indication of torque that is incident on the mechanical element based on the first angle value and the second angle value.

23. The system of claim 22, wherein:
the first angle value is generated based on a difference between signals Bx1 and Bx2 and a difference between signals By1 and By2;
the second angle value is generated based on a difference between signals Bx1 and Bx4 and a difference between signals By1 and By4.

24. The system of claim 22, wherein the mechanical element includes a torsion bar.

25. A method, comprising:
receiving signals Bx1 and By1 that are associated with first and second ring magnets, the signal Bx1 being indicative of a strength of a radial or axial magnetic field that is measured by a first magnetic field sensor, and the signal By1 being indicative of a strength of a tangential magnetic field that is measured by the first magnetic field sensor;
receiving signals Bx2 and By2 that are associated with the first and second ring magnets, the signal Bx2 being indicative of a strength of a radial or axial magnetic field that is measured by a second magnetic field sensor, and the signal By2 being indicative of a strength of a tangential magnetic field that is measured by the second magnetic field sensor;
receiving signals Bx3 and By3 that are associated with the first and second ring magnets, the signal Bx3 being indicative of a strength of a radial or axial magnetic field that is measured by a third magnetic field sensor, and the signal By3 being indicative of a strength of a tangential magnetic field that is measured by the third magnetic field sensor;
receiving signals Bx4 and By4 that are associated with the first and second ring magnets, the signal Bx4 being indicative of a strength of a radial or axial magnetic field that is measured by a fourth magnetic field sensor, and the signal By4 being indicative of a strength of a tangential magnetic field that is measured by the fourth magnetic field sensor;
calculating a first angle value based on signals Bx1, Bx2, By1, By2, and a count npp1 of pole pairs in first ring magnet;
calculating a second angle value based on signals Bx3, Bx4, By3, By4, and a count npp2 of pole pairs in the second ring magnet; and
calculating an indication of torque based on the first angle value and the second angle value,
wherein npp1≥3, npp1 is an odd integer, npp2=4*m*npp2, m is an integer, and m≥1.

26. The method of claim 25, wherein the first ring magnet is coupled to a first portion of mechanical element, the second ring magnet is coupled to a second portion of a mechanical element, and the torque is one that is incident on the mechanical element.

27. The method of claim 25, wherein:
the first angle value is calculated based on a difference between signals Bx1 and Bx2 and a difference between signals By1 and By2;
the second angle value is calculated based on a difference between signals Bx3 and Bx4 and a difference between signals By3 and By4.

28. The method of claim 25, wherein the first and second angle values are calculated in accordance with the equations of:
$$\begin{matrix}Δ X 1 = Bx 1 - Bx 2 \\ Δ Y 1 = By 1 - By 2 \\ Δ X 2 = Bx 3 - Bx 4 \\ Δ Y 2 = By 3 - By 4 \\ Θ 1 = \frac{atan 2 ( Δ Y 1 , Δ X 1 )}{npp 1} \\ Θ 2 = \frac{atan 2 ( Δ Y 2 , Δ X 2 )}{npp 2}\end{matrix}$$
where Θ1 is the first angle value and Θ2 is the second angle value.

29. The method of claim 25, wherein the indication of torque is calculated in accordance with the equation of:
$$Γ = k \times ( Θ 1 - Θ 2 )$$
where Θ1 is the first angle value, Θ2 is the second angle value, Γ is the indication of torque, and k is a constant.

30. A method, comprising:
receiving signals Bx1 and By1 that are associated with first and second ring magnets, the signal Bx1 being indicative of a strength of a radial or axial magnetic field that is measured by a first magnetic field sensor, and the signal By1 being indicative of a strength of a tangential magnetic field that is measured by the first magnetic field sensor;
receiving signals Bx2 and By2 that are associated with the first and second ring magnets, the signal Bx2 being indicative of a strength of a radial or axial magnetic field that is measured by a second magnetic field sensor, and the signal By2 being indicative of a strength of a tangential field that is measured by the second magnetic field sensor;
receiving signals Bx4 and By4 that are associated with the first and second ring magnets, the signal Bx4 being indicative of a strength of a radial or axial magnetic field that is measured by a third magnetic field sensor (124), and the signal By4 being indicative of a strength of a tangential magnetic field that is measured by the third magnetic field sensor;
calculating a first angle value based on signals Bx1, Bx2, By1, By2, and a count npp1 of pole pairs in first ring magnet;
calculating a second angle value based on signals Bx1, Bx4, By1, By4, and a count npp2 of pole pairs in the second ring magnet; and
calculating an indication of torque based on the first angle value and the second angle value,
wherein npp1≥3, npp1 is an odd integer, npp2=4*m*npp2, m is an integer, and m≥1.

31. The method of claim 30, wherein the first ring magnet is coupled to a first portion of mechanical element, the second ring magnet is coupled to a second portion of a mechanical element, and the torque is one that is incident on the mechanical element.

32. The method of claim 30, wherein:
the first angle value is calculated based on a difference between signals Bx1 and Bx2 and a difference between signals By1 and By2;
the second angle value is calculated based on a difference between signals Bx1 and Bx4 and signals By1 and By4.

33. The method of claim 30, wherein the first and second angle values are calculated in accordance with the equations of:
$$\begin{matrix}Δ X 1 = Bx 1 - Bx 2 \\ Δ Y 1 = By 1 - By 2 \\ Δ X 2 = Bx 1 - Bx 4 \\ Δ Y 2 = By 1 - By 4 \\ Θ 1 = \frac{atan 2 ( Δ Y 1 , Δ X 1 )}{npp 1} \\ Θ 2 = \frac{atan 2 ( Δ Y 2 , Δ X 2 )}{npp 2}\end{matrix}$$
where Θ1 is the first angle value and Θ2 is the second angle value.

34. The method of claim 30, wherein the indication of torque is calculated in accordance with the equation of:
$$Γ = k \times ( Θ 1 - Θ 2 )$$
where Θ1 is the first angle value, Θ2 is the second angle value, Γ is the indication of torque, and k is a constant.

35. A system, comprising:
a memory
a processing circuitry that is operatively coupled to the memory, the processing circuitry being configured to:
receive signals Bx1 and By1 that are associated with first and second ring magnets, the signal Bx1 being indicative of a strength of a radial or axial magnetic field that is measured by a first magnetic field sensor, and the signal By1 being indicative of a strength of a tangential magnetic field that is measured by the first magnetic field sensor;
receive signals Bx2 and By2 that are associated with the first and second ring magnets, the signal Bx2 being indicative of a strength of a radial or axial magnetic field that is measured by a second magnetic field sensor, and the signal By2 being indicative of a strength of a tangential magnetic field that is measured by the second magnetic field sensor;
receive signals Bx3 and By3 that are associated with the first and second ring magnets, the signal Bx3 being indicative of a strength of a radial or axial magnetic field that is measured by a third magnetic field sensor, and the signal By3 being indicative of a strength of a tangential magnetic field that is measured by the third magnetic field sensor; and
receive signals Bx4 and By4 that are associated with the first and second ring magnets, the signal Bx4 being indicative of a strength of a radial or axial magnetic field that is measured by a fourth magnetic field sensor, and the signal By4 being indicative of a strength of a tangential magnetic field that is measured by the fourth magnetic field sensor;
calculate a first angle value based on signals Bx1, Bx2, By1, By2, and a count npp1 of pole pairs in first ring magnet;
calculate a second angle value based on signals Bx3, Bx4, By3, By4, and a count npp2 of pole pairs in the second ring magnet; and
calculate an indication of torque based on the first angle value and the second angle value, wherein npp1≥3, npp2=4*m*npp2, m is an integer, and m≥1.

36. The system of claim 30, wherein:
the first angle value is calculated based on a difference between signals Bx1 and Bx2 and a difference between signals By1 and By2;
the second angle value is calculated based on a difference between signals Bx3 and Bx4 and signals By3 and By4.

37. A method, comprising:
a memory
a processing circuitry that is operatively coupled to the memory, the processing circuitry being configured to:
receiving signals Bx1 and By1 that are associated with first and second ring magnets, signal Bx1 being indicative of a strength of a radial or axial magnetic field that is measured by a first magnetic field sensor, and the signal By1 being indicative of a strength of a tangential magnetic field that is measured by the first magnetic field sensor;
receiving signals Bx2 and By2 that are associated with the first and second ring magnets, signal Bx2 being indicative of a strength of a radial or axial magnetic field that is measured by a second magnetic field sensor, and the signal By2 being indicative of a strength of a tangential magnetic field that is measured by the second magnetic field sensor;
receiving signals Bx4 and By4 that are associated with the first and second ring magnets, signal Bx4 being indicative of a strength of a radial or axial magnetic field that is measured by a third magnetic field sensor (124), and the signal By4 being indicative of a strength of a tangential magnetic field that is measured by the third magnetic field sensor;
calculating a first angle value based on signals Bx1, Bx2, By1, By2, and a count npp1 of pole pairs in first ring magnet;
calculating a second angle value based on signals Bx1, Bx4, By1, By4, and a count npp2 of pole pairs in the second ring magnet; and
calculated an indication of torque based on the first angle value and the second angle value, wherein npp1≥3, npp2=4*m*npp2, m is an integer, and m≥1.

38. The method of claim 37, wherein:
the first angle value is calculated based on a difference between signals Bx1 and Bx2 and a difference between signals By1 and By2;
the second angle value is calculated based on a difference between signals Bx1 and Bx4 and a difference signals By1 and By4.
